(19) United States
(12) Patent Application Publication
(10) Pub. No.: US 2013/0316818 A1
(43) Pub. Date: Nov. 28, 2013

(54) INCORPORATING DATA INTO A WAGERING GAME

(71) Applicant: WMS GAMING, INC., Waukegan, IL (US)

(72) Inventors: Edward Q. Earley, Chicago, IL (US); Damon E. Gura, Chicago, IL (US); Robert L. Kyte, Chicago, IL (US); Richard B. Robbins, Glenview, IL (US)

(73) Assignee: WMS GAMING, INC., Waukegan, IL (US)

(21) Appl. No.: 13/826,335

(22) Filed: Mar. 14, 2013

Related U.S. Application Data
(60) Provisional application No. 61/651,617, filed on May 25, 2012.

(51) Int. Cl. G07F 17/32

(52) U.S. Cl. CPC G07F 17/3211
USPC 463/31

(57) ABSTRACT

Systems and methods receive data from one or more source databases into a target database and use the data to personalize or customize a wagering game to a game player. The data may be social network data regarding a player's social contacts, fantasy sports league data associated with the player or other data associated with the player. The data is normalized and data elements from the data are mapped to game elements or symbols to create personalized game elements or symbols. The personalized game elements or symbols are then used as part of a wagering game.

### RELATED APPLICATIONS

This application claims the priority benefit of U.S. Provisional Application Ser. No. 61/651,617 filed May 25, 2012.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### FIELD

Embodiments of the inventive subject matter relate generally to game and wagering game systems, and more particularly to systems incorporating data from third party sources into games and wagering game systems.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 is a block diagram illustrating system for incorporating third party data into a wagering game according to embodiments.

FIG. 2 is a flowchart illustrating a method for incorporating third party data into a wagering game according to embodiments.

FIG. 3 is an example mapping of third party data to game symbols.

FIG. 4 is an example game symbol.

FIG. 5 is a flowchart illustrating a method for selecting third party data to incorporate into a wagering game according to embodiments.

FIG. 6 is a block diagram illustrating a wagering game machine architecture, according to example embodiments of the invention.

FIG. 7 is a perspective view of a wagering game machine, according to example embodiments of the invention.

FIG. 8 is a block diagram illustrating a wagering game network, according to example embodiments of the invention

### DESCRIPTION OF THE EMBODIMENTS

This description of the embodiments is divided into five sections. The first section provides an introduction to embodiments of the invention, while the second section describes example wagering game machine architectures. The third section describes example operations performed by some embodiments and the fourth section describes example wagering game machines in more detail. The fifth section presents some general comments.

### Introduction

This section provides an introduction to some embodiments of the invention. In general, the embodiments incorporate data from third party source such as social network sites into wagering games.

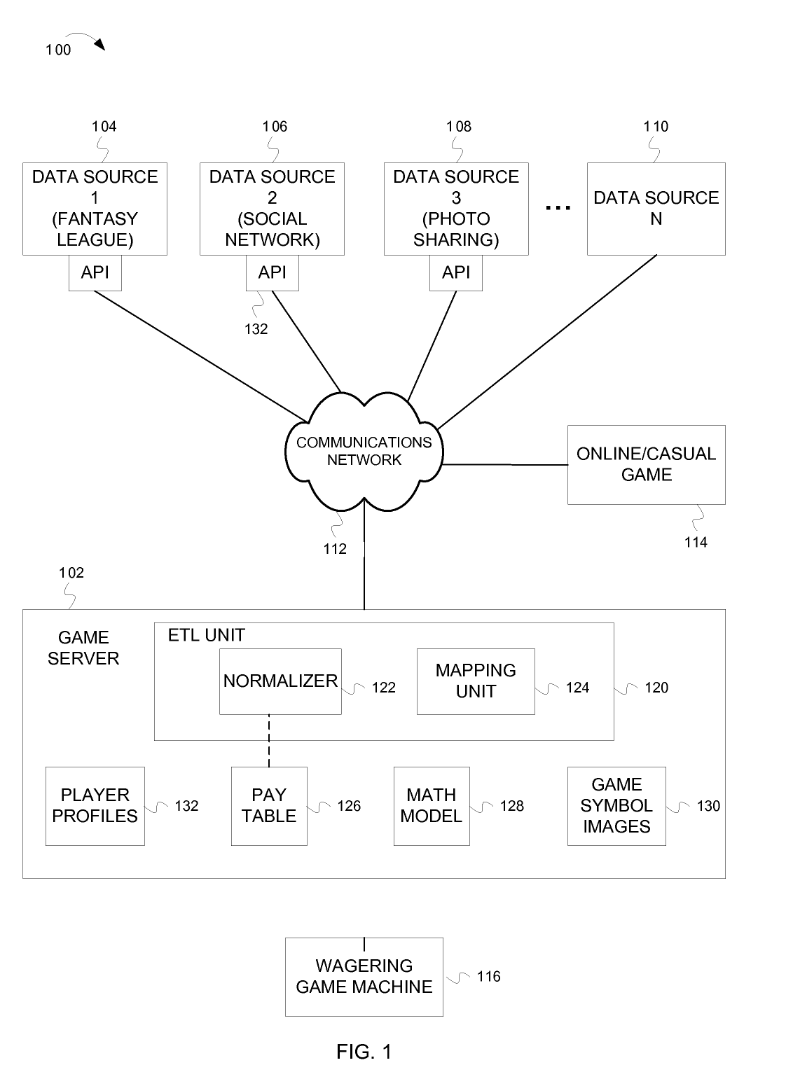

FIG. 1 is a block diagram illustrating a system 100 for incorporating third party data into a wagering game according to embodiments. In some embodiments, system 100 includes a game server 102 coupled to one or more data sources 104-110 through a communications network 112. System 100 may include either or both a wagering game machine 116 and online game 114. Communications network 112 may be any type of network, including local area networks, wide area networks, private networks, public networks, or any combination thereof. In some embodiments, communication network 112 includes the Internet.

Game server 102 provides games or game elements for wagering games on wagering game machine 116 or for online games 114. Such game elements can include one or more of pay tables 126, math models 128 or game symbol images 130. Pay table 126 defines payout amounts for various combinations of symbols that may be randomly generated by a wagering game. For example, pay table 126 may define payout amounts for combinations of reel symbols, cards, dice or other game elements. Math model 128 defines parameters and functions for various elements that define in mathematical terms aspects of a game. Game symbol images 130 are images that appear on game elements such as reel symbols, card faces, die faces or other game elements.

Data sources 104-110 are third party systems (with respect to game server 102), that provide data that may be used by game server 102 to customize games provided to wagering game machine 116 and online game 114. Data sources 104-110 may be any type of system that can provide data for use in customizing a game. For example, in some embodiments, data source 104 is a system that maintains data for a fantasy sports league. The fantasy sports league can be any type of sports league, including football, baseball, basketball, hockey etc. In some embodiments, data source 106 can be a social networking system such as Facebook, LinkedIn, Google+, Twitter, Classemates.com etc. In some embodiments, data source 108 can be a photo sharing site such as Flickr. Data source 110 represent any of a multitude of other potential data sources such as systems providing financial data, investment data, weather data, travel data etc. The inventive subject matter is not limited to any particular data source. Further, it should be noted that game server 102 may have access to multiple data sources and can use the data sources alone or in combination to customize games or game elements.

Game server 102 includes an extract, transform and load (ETL) unit 120 that obtains data from a data source and performs operations on the obtained data to transform the data into a form that can be used readily by the server to provide customized games. In some embodiments, ETL unit 120 obtains data through an API 132. API 132 is an interface that is provided and published by the third party data source to enable systems to obtain data from the data source. In some embodiments, API 132 may be a web service interface. As an example API, Facebook provides a “Facebook Data Connect” API that allows systems to obtain data from the Facebook social networking system. Other APIs that may be used include SOAP or JSONG. In alternative embodiments, game server 102 may obtain data from a structured file (e.g., an XML file) that is transferred from the data source to game server 102 over network 112.

In some embodiments, ETL unit 120 includes a normalization unit 122. Normalization unit 122 transforms the data using statistical measurements and functions to bring the incoming data into a common set of divisions or common scale that can be used fit the data to a pay table or math model for a game.

ETL unit 120 may also include mapping unit 124 that maps the data received from data sources 104-110 to game elements (e.g., pay tables, math models, game symbol images etc.) or game templates for games provided by game server 120. Further details on the mapping from data to game elements that may be performed by mapping unit 124 are provided below.

Player profiles 132 may be used by a game server 102 to determine which data sources to obtain data from. Player profiles are typically associated with a player identification. The profile for a player in some embodiments includes various data sources that the player is interested in using to personalize or customize a game. Upon logging in to a wagering game, for example by inserting a player tracking card or entering login credentials, the game server can use data from the data sources in the game player's profile to customize a wagering game or online game for the game player.

Although FIG. 1 describes some embodiments, the following sections describe many other features and embodiments.

### Example Operations

This section describes operations associated with some embodiments of the invention. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

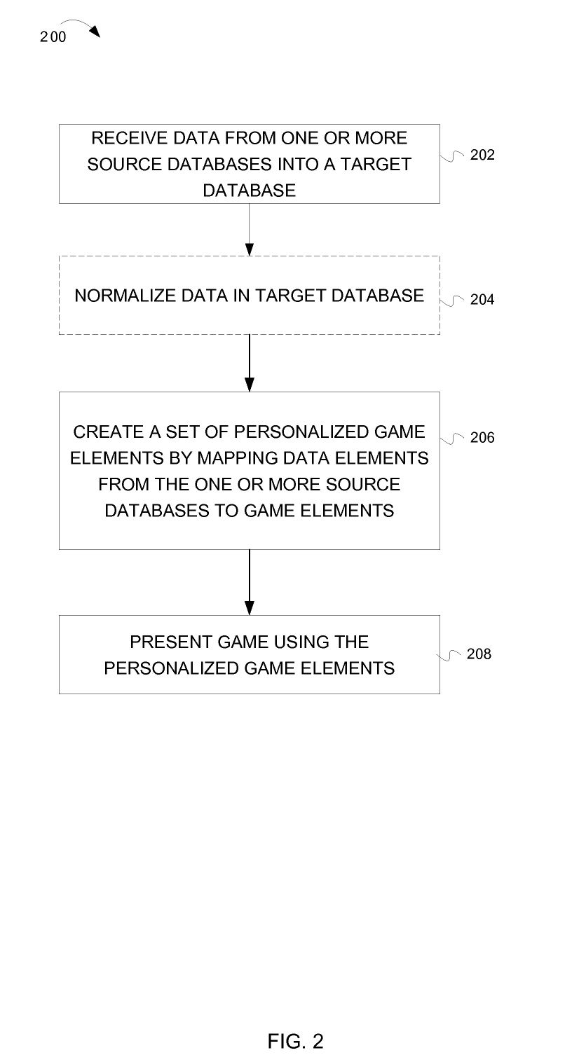

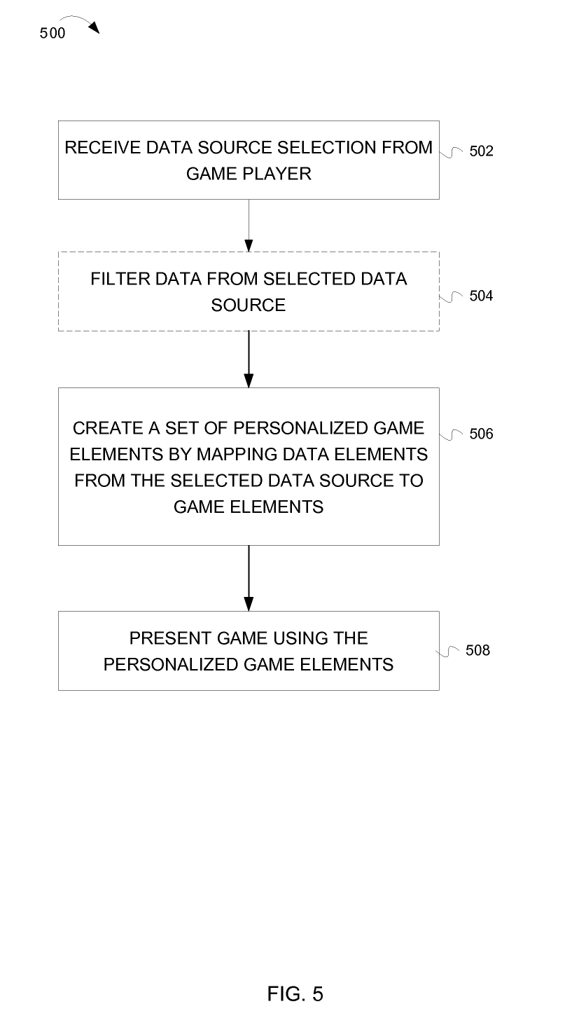

The section will discuss FIGS. 2-5. The discussion of FIGS. 2-4 will describe operations for incorporating third party data into a wagering game or online game. The discussion of FIG. 5 will describe operations for providing an option for a user to select data sources for use in incorporating third party data into games.

FIG. 2 is a flowchart illustrating a method 200 for incorporating third party data into a wagering game according to embodiments. Method 200 begins at block 202 by receiving data from one or more third party systems. The data may be obtained using various methods. For example, as discussed above, in some embodiments a game server may use an API provided by the data source to obtain desired data. In alternative embodiments, a data source may prepare an extract file, typically in a structured format, containing the desired data that is then transferred over a network such as the internet from the data source to the game server. In some embodiments, data may be provided as an XML (eXtensible Markup Language) file.

Data may be obtained at regular intervals that may vary depending on the data source. For example, when obtaining data from a system that maintains data for a fantasy football league, weekly receipt of the data may sufficient given that games are typically played once a week. However, for a fantasy baseball or basketball league, daily updates of the source data may be required as games are played more frequently in these sports. Financial or investment data may be obtained even more frequently due to the fact that such data changes frequently.

In some embodiments, the data may be obtained in real time. As an example, a Twitter feed or RSS feed may be a source of data. Avatars, symbols or text associated with real time data feeds may be used to create personalized symbols for a wagering game or for otherwise personalizing a wagering game.

At block 204, the system optionally normalizes the data received from a third party system. Such normalization may include scaling or otherwise transforming the data so that the third party data can conform to the requirements of a pay table or math model used by a game provided by the game server. Normalization is desirable in some embodiments, because the normalized data can provide a better basis for randomly selecting or mapping data elements in the data source. In some embodiments, a pay table (e.g., pay table 126) is used to govern the normalization. The incoming data is selected, scaled, transformed or grouped to conform with the groupings and probabilities of pay table elements. In some embodiments, the pay table may be a fixed pay table that is the same for all players. In alternative embodiments, the pay table may vary. For example, the pay table may be different depending on the status of a player. The status may be determined by a player tracking system or it may be configured by a gaming establishment. The pay table may vary based on other parameters such as time of day, day of week, seasons, holidays, special events etc. The normalization may thus take into account the pay table for a particular player and the normalization may vary in real time based on the pay table being used.

At block 206, a game server maps the data (potentially normalized) received from the third party system or systems to game elements. Various types of mapping are possible and will vary depending on the type of source data. For example, in the case of fantasy sports leagues, points accumulated by a sports player based on their performance over a period of time may be used to map the sports player's image and performance data to a game symbol such as a reel symbol, a card face, or the face of a die. A wagering game player may specify their fantasy league team, and the team's players' fantasy points and other data may be used as part of the mapping. Thus the game symbols are personalized to the wagering game player based on statistics taken from the player's fantasy sports team.

As noted above, other types of data can be used to personalize or customize a wagering game. Data from a wagering game player's stock portfolio may be used. As an example, stock symbols may be mapped to game symbols. The stock symbols may be mapped such that the highest gaining stocks could be mapped to symbols with a higher payback. Similarly, demographic data obtained from a social network site using the wagering game player login credentials may be used to map images of friends to game symbols. Likewise, photos obtained from photo sharing sites may be mapped to game symbols using metadata associated with the photos.

Mapping may be accomplished in various ways. In some embodiments, a game designer may provide a mapping of various data elements in various data sources to game elements of a game. In alternative embodiments, a game player can specify a mapping of data elements to game elements. For example, a game player may choose to map a fantasy football team to game symbols. The game player may identify particular data elements the player is interested in such as fantasy points, college, position etc. that are to be used in the mapping. In further alternative embodiments, heuristics may be employed that analyze a data source's data elements and automatically determines a mapping from data elements to game elements.

At block 208, the customized or personalized game symbols may then be presented during play of a wagering game or casual game.

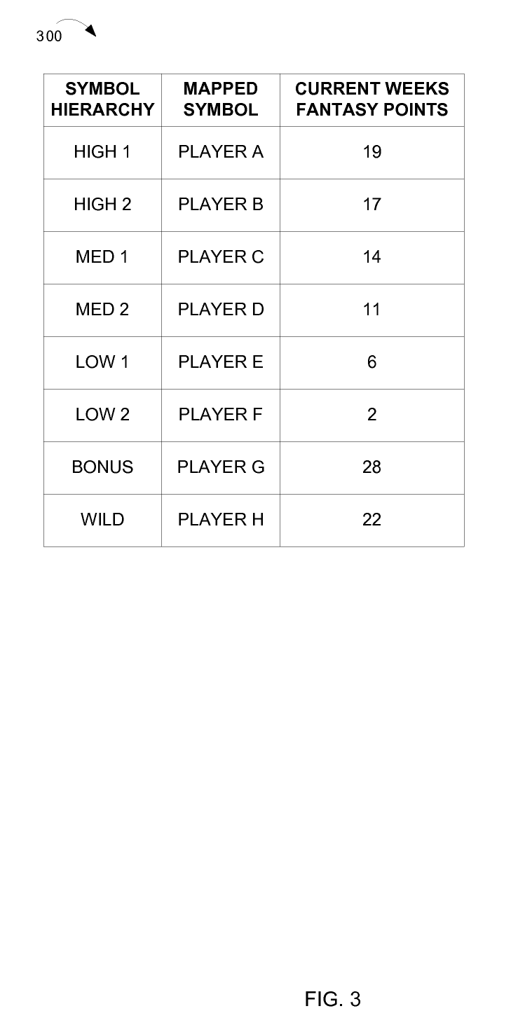

FIG. 3 is an example mapping 300 of third party data to game symbols. In the example illustrated in FIG. 3, a wagering game player's fantasy sports league team data is mapped to symbols, with the current weeks fantasy points being used to map from players in the league to certain symbols of a slots based wagering game. As indicated in the “Symbol Hierarchy”, the wagering game incorporates high symbols, medium symbols and low symbols along with a bonus symbol and a wild symbol. High symbols are associated with high payout amounts, medium symbols are associated with medium payout amounts, and low symbols are associated with low payout amounts. The math model 128 (FIG. 1) associated with the symbol hierarchy may be a predetermined math model (i.e., each reel strip has a predetermined layout of symbols so as to yield winning symbol combinations having associated payouts and probabilities of occurrence, thereby yielding a slot game with a predetermined overall payback percentage, e.g., 90%). Winning symbol combinations may, for example, be three, four, and five occurrences of a particular symbol appearing “left-to-right” along an active payline.

A bonus symbol, if it appears on a reel, causes a bonus game to commence. In some embodiments, a predetermined number of bonus symbols, e.g., three, are required in order to trigger a bonus game. Depending upon the desired game design, the bonus symbols may or may not need to appear along an active payline in order to trigger a bonus game. A wild symbol matches any symbol, with the potential exception of the bonus symbol.

As illustrated in the example shown in FIG. 3, the player with the highest fantasy point total for the current week is mapped to the bonus symbol, the player with the next highest fantasy point total for the current week is mapped to the wild symbol, followed by mapping players to the high, medium and low symbols in descending order of fantasy points for the current week. Those of skill in the art having the benefit of the disclosure will appreciate that other mappings are possible and within the scope of the inventive subject matter. In the example shown in FIG. 3, the mapping was based on a current week's data. The mapping may be based on other time periods such as a year-to-date, current season, previous season etc. Additionally, other data or statistics may be used in the mapping. For example, the wild symbol may be assigned to the player whose performance statistics exhibited the largest variance from their average performance. Thus a player who had a mediocre or even low average rating, but a much better than normal week, may be assigned a symbol. In further embodiments, improvement in player statistics may be used to map players to game symbols.

As discussed above, other types of data may be used in addition to or instead of sports data. For instance, a wagering game player's stock portfolio may be mapped to game symbols. As an example, the wagering game player's highest performing stock may be assigned to the bonus symbol, with other high performing stocks assigned to the wild, high, medium and low symbols.

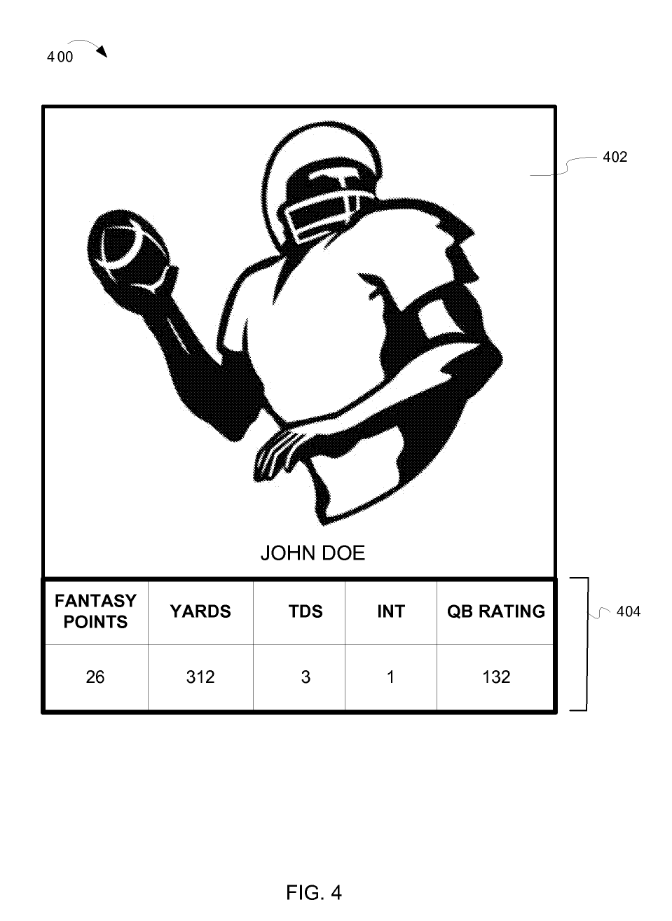

FIG. 4 illustrates an example game symbol 400 that may be produced using the mapping methods discussed above. Symbol 400 includes an image area 402 that comprises an image of a football player from a wagering game player's fantasy football league team. Statistics area 404 provides one or more statistics for the football player mapped to the game symbol 400. The statistics area may display a subset of available statistics, and may include fewer or more statistics than were used in the mapping. Alternatively, the statistics area may be a scrolling region on the symbol, with statistics scrolling across the statistics area. While the example illustrated in FIG. 4 shows a horizontal statistics area on the bottom of the game symbol, those of skill in the art having the benefit of the disclosure will appreciate that a statistics area could be presented vertically or some other orientation, and at the top or sides or other position of the game symbol.

The statistics area may include various data and statistics regarding the player mapped to the game symbol. Such data and statistics may include in various embodiments current injury status (out (O), doubtful (D), questionable (Q), probable (P))) and abbreviated statistics for his most recent week of play (e.g., rush yards, receiving yards, passing yards, number of touchdowns), player name, uniform number, position, team name, years of experience, college, height, weight, date of birth, most recent week's statistics, season-to-date statistics, player news, etc. Fantasy points for current week can be based on either a particular league's scoring system or a typical scoring system.

FIG. 5 is a flowchart illustrating a method 500 for selecting third party data to incorporate into a wagering game according to embodiments. Method 500 begins at block 502 with receiving a selection of a data source from a game player. The selection may be stored in a profile or configuration for the game player and used for future games, or the selection may be applied to a game the player has selected to play next.

At block 504, data from the selected data source may be filtered. In some embodiments, the data is filtered in order to produce a domain of data that is of a size that can be reasonably mapped to game symbol elements. Filtering of the data may comprise performing a matching algorithm on one or more of the elements in the data. For example, in the case of a fantasy sports teams, the data may be filtered by including only those players who have been in the league for a certain number of years, players that play a particular position, or players that attended the same college or university. The filtering may be performed on one data element or multiple data elements.

### Operating Environment

This section describes an example operating environment and presents structural aspects of some embodiments. This section includes discussion about wagering game machine architectures and wagering game networks.

### Wagering Game Machine Architectures

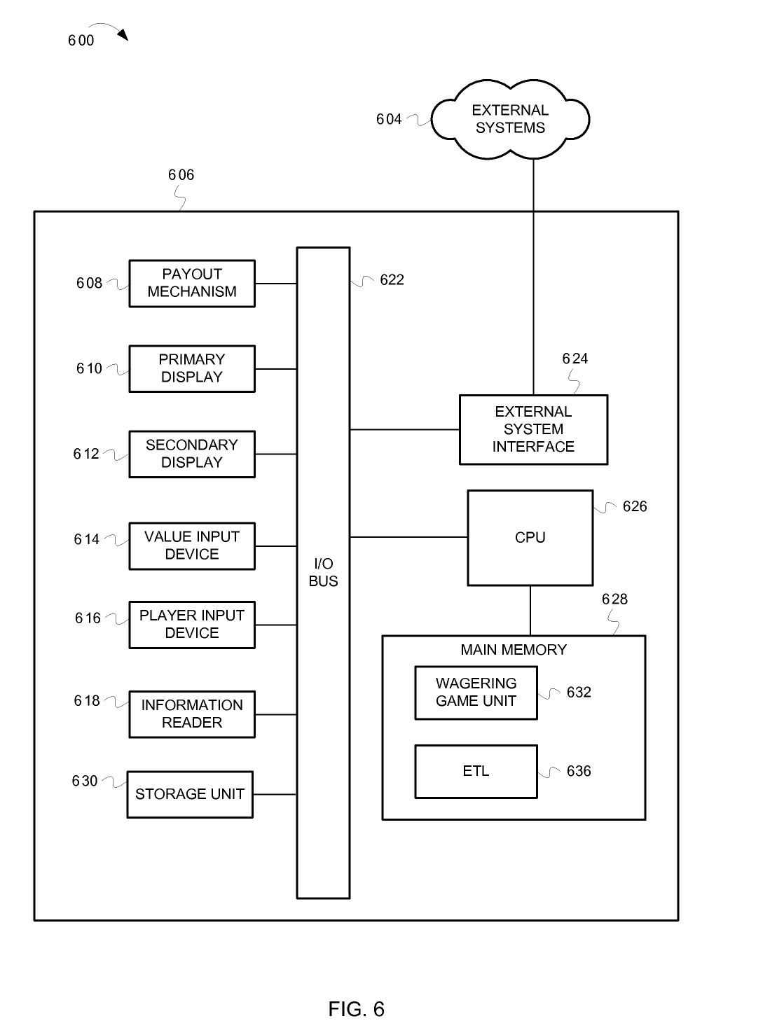

FIG. 6 is a block diagram illustrating a wagering game machine architecture, according to example embodiments of the invention. As shown in FIG. 6, the wagering game machine architecture 600 includes a wagering game machine 606, which includes a central processing unit (CPU) 626 connected to main memory 628. The CPU 626 can include any suitable processor, such as an Intel® Pentium processor, Intel® Core 2 Duo processor, AMD Opteron™ processor, or UltraSPARC processor. The main memory 628 includes a wagering game unit 632. In one embodiment, the wagering game unit 632 can present wagering games, such as video poker, video black jack, video slots, video lottery, etc., in whole or part.

The CPU 626 is also connected to an input/output (I/O) bus 622, which can include any suitable bus technologies, such as an AGTL+ frontside bus and a PCI backside bus. The I/O bus 622 is connected to a payout mechanism 608, primary display 610, secondary display 612, value input device 614, player input device 616, information reader 618, and storage unit 630. The player input device 616 can include the value input device 614 to the extent the player input device 616 is used to place wagers. The I/O bus 622 is also connected to an external system interface 624, which is connected to external systems 604 (e.g., wagering game networks).

In one embodiment, the wagering game machine 606 can include additional peripheral devices and/or more than one of each component shown in FIG. 6. For example, in one embodiment, the wagering game machine 606 can include multiple external system interfaces 624 and/or multiple CPUs 626. In one embodiment, any of the components can be integrated or subdivided.

Any component of the architecture 600 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

While FIG. 6 describes an example wagering game machine architecture, this section continues with a discussion wagering game networks.

### Wagering Game Networks

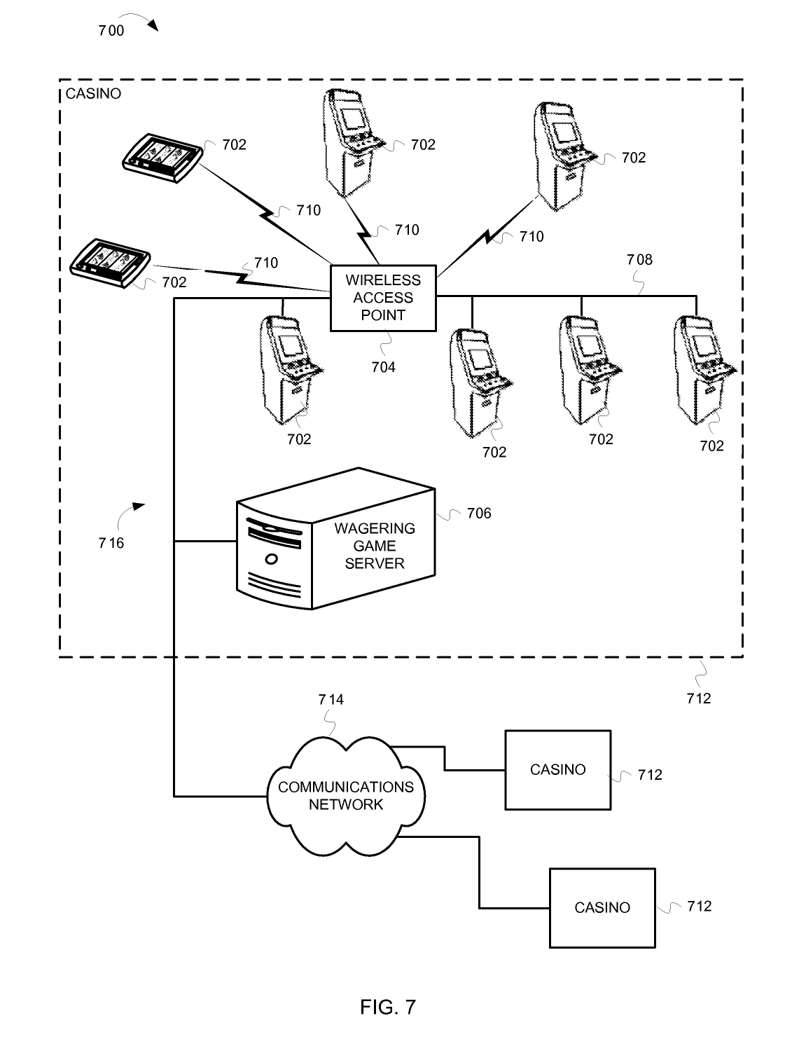

FIG. 7 is a block diagram illustrating a wagering game network 700, according to example embodiments of the invention. As shown in FIG. 7, the wagering game network 700 includes a plurality of casinos 712 connected to a communications network 714.

Each casino 712 includes a local area network 716, which includes an access point 704, a wagering game server 706, and wagering game machines 702. The access point 7304 provides wireless communication links 710 and wired communication links 708. The wired and wireless communication links can employ any suitable connection technology, such as Bluetooth, 802.11, Ethernet, public switched telephone networks, SONET, etc. In some embodiments, the wagering game server 706 can serve wagering games and distribute content to devices located in other casinos 712 or at other locations on the communications network 714.

The wagering game machines 702 described herein can take any suitable form, such as floor standing models, handheld mobile units, bartop models, workstation-type console models, etc. Further, the wagering game machines 702 can be primarily dedicated for use in conducting wagering games, or can include non-dedicated devices, such as mobile phones, personal digital assistants, personal computers, etc. In one embodiment, the wagering game network 700 can include other network devices, such as accounting servers, wide area progressive servers, player tracking servers, and/or other devices suitable for use in connection with embodiments of the invention.

In some embodiments, wagering game machines 702 and wagering game servers 706 work together such that a wagering game machine 702 can be operated as a thin, thick, or intermediate client. For example, one or more elements of game play may be controlled by the wagering game machine 702 (client) or the wagering game server 706 (server). Game play elements can include executable game code, lookup tables, configuration files, game outcome, audio or visual representations of the game, game assets or the like. In a thin-client example, the wagering game server 706 can perform functions such as determining game outcome or managing assets, while the wagering game machine 702 can present a graphical representation of such outcome or asset modification to the user (e.g., player). In a thick-client example, the wagering game machines 702 can determine game outcomes and communicate the outcomes to the wagering game server 706 for recording or managing a player's account.

In some embodiments, either the wagering game machines 702 (client) or the wagering game server 706 can provide functionality that is not directly related to game play. For example, account transactions and account rules may be managed centrally (e.g., by the wagering game server 706) or locally (e.g., by the wagering game machine 702). Other functionality not directly related to game play may include power management, presentation of advertising, software or firmware updates, system quality or security checks, etc.

Any of the wagering game network components (e.g., the wagering game machines 702) can include hardware and machine-readable media including instructions for performing the operations described herein.

### Example Wagering Game Machines

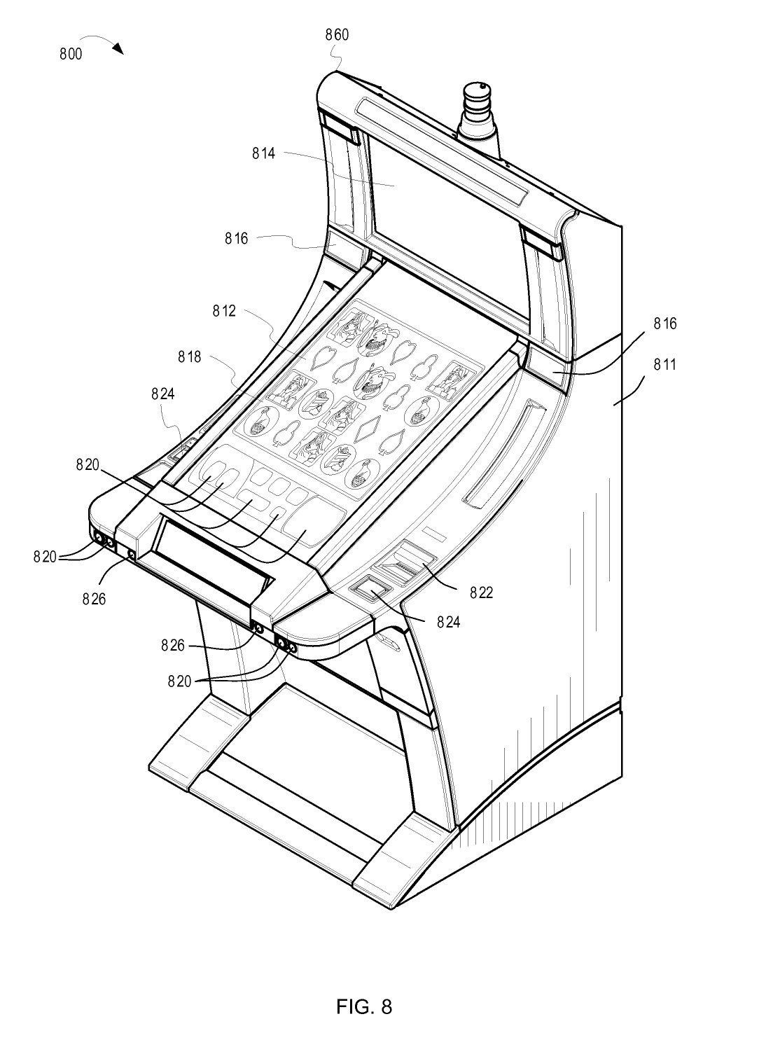

FIG. 8 is a conceptual diagram that illustrates an example of a wagering game system 800, according to some embodiments. In FIG. 8, the wagering game system 800 includes a wagering game machine 860 similar to those used in gaming establishments, such as casinos. The wagering game machine 860 may, in some examples, be referred to as a gaming terminal or an electronic gaming machine. The wagering game machine 860 may have varying structures and methods of operation. For example, the wagering game machine 860 may include electromechanical components configured to play mechanical slots. In another example, the 860 includes electronic components configured to play a video casino game, such as slots, keno, poker, blackjack, roulette, craps, etc. The wagering game machine 860 is depicted as a floor-standing model. However, other examples of wagering game machines include handheld mobile units, bartop models, workstation-type console models, etc. Further, the wagering game machine 860 may be primarily dedicated for use in conducting wagering games, or may include non-dedicated devices, such as mobile phones, personal digital assistants, personal computers, etc. Exemplary types of wagering game machines are disclosed in U.S. Pat. No. 6,517,433 and Patent Application Publication Nos. US2010/0062196 and US2010/0234099, which are incorporated herein by reference in their entireties.

The wagering game machine 860 illustrated in FIG. 8 comprises a cabinet 811 that may house various input devices, output devices, and input/output devices. By way of example, the wagering game machine 860 includes a primary display area 812, a secondary display area 814, and one or more audio speakers 816. The primary display area 812 or the secondary display area 814 may include one or more of a cathode ray tube (CRT), a high resolution liquid crystal display (LCD), a plasma display, a light emitting diode (LED) display, a three-dimensional (3D) display, a video display, or a combination thereof. In some examples, the primary display area 812 or the secondary display area 814 includes mechanical reels to display a wagering game outcome. In some example, the primary display area 812 or the secondary display area 814 present a transmissive video display disposed in front of a mechanical-reel display to portray a video image superimposed upon the mechanical-reel display. In FIG. 8, the wagering game machine 860 is a “slant-top” version in which the primary display 812 is slanted (e.g., at about a thirty-degree angle toward the player of the wagering game machine 860). Another example of wagering game machine 860 is an “upright” version in which the primary display 814 is oriented vertically relative to the player. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the wagering game machine 860. The wagering game machine 860 includes a touch screen(s) 818 mounted over the primary or secondary areas, buttons 820 on a button panel, bill validator 822, information reader/writer(s) 824, and player-accessible port(s) 826 (e.g., audio output jack for headphones, video headset jack, USB port, wireless transmitter/receiver, etc.). It should be understood that numerous other peripheral devices and other elements exist and are readily utilizable in any number of combinations to create various forms of a wagering game machine in accord with the present concepts.

Input devices, such as the touch screen 818, buttons 820, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer readable program code embodied in the medium. The described embodiments may be provided as a computer program product that may include a machine-readable storage medium having stored thereon instructions, which may be used to program a computer system to perform a process according to embodiments(s), whether presently described or not, because every conceivable variation is not enumerated herein. A machine-readable storage medium includes any mechanism that stores information in a form readable by a machine (e.g., a wagering game machine, computer, etc.). For example, machine-readable storage media includes read only memory (ROM), random access memory (RAM), magnetic disk storage media, optical storage media (e.g., CD-ROM), flash memory machines, erasable programmable memory (e.g., EPROM and EEPROM); etc. Some embodiments of the invention can also include machine-readable signal media, such as any media suitable for transmitting software over a network.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method for providing a wagering game, the method comprising:
receiving, into a target database, data from one or more source databases;
normalizing, by one or more processors, the received data;
determining, by at least one of the one or more processors, a mapping from data elements in the data to game elements of a wagering game, the mapping using the normalized data to create a set of one or more personalized game elements; and
presenting, on a display device the wagering game using the personalized game elements.

2. The method of claim 1, wherein the game elements comprise game symbols, and wherein the game symbols include image data from the one or more source databases.

3. The method of claim 2, wherein the image data for a game symbol includes image data for a fantasy sports team player, and wherein the game symbol further includes data associated with the fantasy sports team player.

4. The method of claim 3, wherein the mapping of the fantasy sports team player to the game symbol includes mapping according to a performance statistic for the fantasy sports team player relative to other fantasy sports team players in the one or more source databases.

5. The method of claim 1, further comprising filtering the target database data.

6. The method of claim 1, further comprising receiving a wagering game player's selection of the one or more source databases.

7. The method of claim 1, further comprising receiving a wagering game player's selection of data elements to include in the mapping to game elements.

8. A computer-readable storage medium having stored thereon computer executable instructions for causing one or more processors to perform operations comprising:
receiving, into a target database, data from one or more source databases;
normalizing the received data;
determining a mapping from data elements in the data to game elements of a game, the mapping using the normalized data to create a set of one or more personalized game elements; and
presenting, on a display device, the game using the personalized game elements.

9. The computer-readable storage medium of claim 8, wherein the game elements comprise game symbols, and wherein the game symbols include image data from the one or more source databases.

10. The computer-readable storage medium of claim 9, wherein the image data for a game symbol includes image data for a fantasy sports team player, and wherein the game symbol further includes data associated with the fantasy sports team player.

11. The computer-readable storage medium of claim 10, wherein the mapping of the fantasy sports team player to the game symbol includes mapping according to a performance statistic for the fantasy sports team player relative to other fantasy sports team players in the one or more source databases.

12. The computer-readable storage medium of claim 8, wherein the operations further comprise filtering the target database data.

13. The computer-readable storage medium of claim 8, wherein the operations further comprise receiving a wagering game player's selection of the one or more source databases.

14. The computer-readable storage medium of claim 8, wherein the operations further comprise receiving a wagering game player's selection of data elements to include in the mapping to game elements.

15. The computer-readable medium of claim 8, wherein the game is a wagering game upon which monetary value may be wagered.

16. A system comprising:
a target database configured to receive data from one or more source databases;
at least one processor; and
at least one memory device storing instructions, that when executed by the at least one processor, cause the system to:
normalize the received data, and
determine a mapping from data elements in the data to game elements of a game, the mapping using the normalized data to create a set of one or more personalized game elements.

17. The system of claim 16, and further comprising a display device for presenting the game and the set of one or more personalized game elements.

18. The system of claim 16, wherein the game elements comprise game symbols, and wherein the game symbols include image data from the one or more source databases.

19. The system of claim 18, wherein the image data for a game symbol includes image data for a fantasy sports team player, and wherein the game symbol further includes data associated with the fantasy sports team player.

20. The system of claim 19, wherein the mapping of the fantasy sports team player to the game symbol includes a mapping according to a performance statistic for the fantasy sports team player relative to other fantasy sports team players in the one or more source databases.

21. The system of claim 16, wherein the instructions, when executed by the at least one processor, further cause the system to filter the data from the target database.

22. The system of claim 16, wherein the instructions, when executed by the at least one processor, further cause the system to receive a wagering game player's selection of the one or more source databases.

23. The system of claim 16, wherein the instructions, when executed by the at least one processor, further cause the system to receive a wagering game player's selection of data elements to include in the mapping to game elements.

24. The system of claim 16, wherein the game is a wagering game upon which monetary value may be wagered.

25. A system comprising:
means for receiving, into a target database, data from one or more source databases;
means for normalizing the received data;
means for determining a mapping from data elements in the data to game elements of a wagering game, the mapping using the normalized data to create a set of one or more personalized game elements; and
means for presenting the wagering game using the personalized game elements.

26. The system of claim 25, wherein the game elements comprise game symbols, and wherein the game symbols include image data from the one or more source databases.
